(19) United States
(12) Patent Application Publication
(10) Pub. No.: US 2025/0202662 A1
(43) Pub. Date: Jun. 19, 2025

(54) METHODS FOR TRANSMITTING DOWNLINK FREQUENCY-DOMAIN AGGREGATION PHYSICAL LAYER PROTOCOL DATA UNIT, TRIGGER FRAME, AND UPLINK PHYSICAL LAYER PROTOCOL DATA UNIT

(71) Applicant: MEDIATEK INC., Hsinchu City (TW)

(72) Inventors: You-Wei Chen, San Jose, CA (US); Jianhan Liu, San Jose, CA (US); Gary A. Anwyl, San Jose, CA (US); Shengquan Hu, San Jose, CA (US); Thomas Edward Pare, JR., San Jose, CA (US)

(21) Appl. No.: 18/979,693

(22) Filed: Dec. 13, 2024

Related U.S. Application Data
(60) Provisional application No. 63/609,903, filed on Dec. 14, 2023.
(60) Provisional application No. 63/553,662, filed on Feb. 15, 2024.

(51) Int. Cl. H04L 5/00; H04W 28/06; H04W 72/0453

(52) U.S. Cl. CPC H04L 5/0053; H04W 28/06; H04W 72/0453

(57) ABSTRACT

A method for transmitting a downlink (DL) frequency-domain aggregation physical layer protocol data unit (FD-A-PPDU), wherein the DL FD-A-PPDU at least comprises a first PPDU and a second PPDU, and the method includes: performing a frequency-domain (FD) mask coefficient setting operation upon at least one field comprised in the first PPDU and at least one field comprised in the second PPDU according to a frequency sub-block, in order to generate a masked FD-A-PPDU, wherein the at least one field comprised in the first PPDU corresponds to the at least one field comprised in the second PPDU; and transmitting the masked FD-A-PPDU.

### CROSS REFERENCE TO RELATED APPLICATIONS

This application claims the benefit of U.S. Provisional Application No. 63/609,903, filed on Dec. 14, 2023. Further, this application claims the benefit of U.S. Provisional Application No. 63/553,662, filed on Feb. 15, 2024. The contents of these applications are incorporated herein by reference.

### BACKGROUND

The present invention is related to wireless communication, and more particularly, to methods for transmitting a downlink (DL) frequency-domain aggregation physical layer protocol data unit (FD-A-PPDU), a trigger frame, and an uplink (UL) PPDU, and associated wireless communication devices.

In order to optimize limited wireless resources and achieve better spectrum efficiency, an access point (AP) may perform a dynamic sub-band operation (DSO) in order to address an unbalanced bandwidth issue between the AP and a non-AP (e.g., a station (STA)). More particularly, an FD-A-PPDU may be adopted in order to allow mixed transmission of multiple Wireless Fidelity (Wi-Fi) generation PPDUs. For example, for an AP having channels with 320 MHz, the AP may transmit a Wi-Fi 6 generation PPDU (e.g., a High Efficiency (HE) generation PPDU) to a station corresponding to the HE generation via a primary channel with 160 MHZ (P160), and transmit a Wi-Fi 7 generation PPDU (e.g., an Extremely High Throughput (EHT) generation PPDU) to a station corresponding to the EHT generation via a secondary channel with 160 MHZ (S160). For PPDUs corresponding to different Wi-Fi generations, the fields therein may have a sequence pre-defined in the standard. Some specific fields may be reused between two different Wi-Fi generations. Due to the duplicated sequence, the peak-to-average ratio (PAPR) of the DL FD-A-PPDU may increase.

In addition, in an existing standard, in trigger frame transmitted from the AP to the non-AP STAs, there is an indicator in the common information field for indicating whether the P160 should use the HE generation or the EHT generation, which limits the design flexibility of subsequent Wi-Fi generation versions. For example, the above indicator may cause some problems in a case where the EHT generation with an 80 MHz primary channel and a Wi-Fi 8 generation (e.g., an Ultra High Reliability (UHR) generation) with a 240 MHz secondary channel are adopted.

As a result, a novel method for reducing a PAPR of a DL FD-A-PPDU by performing a FD mask coefficient setting operation upon the DL FD-A-PPDU and a novel method for transmitting a UL FD-A-PPDU with aid of a novel trigger frame format are urgently needed.

### SUMMARY

It is therefore one of the objectives of the present invention to provide methods for transmitting a DL FD-A-PPDU, a trigger frame, and a UL PPDU, and associated wireless communication devices, in order to address the above-mentioned issues.

According to an embodiment of the present invention, a method for transmitting a DL FD-A-PPDU is provided, wherein the DL FD-A-PPDU at least comprises a first PPDU and a second PPDU. The method comprises: performing a FD mask coefficient setting operation upon at least one field comprised in the first PPDU and at least one field comprised in the second PPDU according to a frequency sub-block in a frequency band used for transmitting the DL FD-A-PPDU, in order to generate a masked FD-A-PPDU, wherein the at least one field comprised in the first PPDU corresponds to the at least one field comprised in the second PPDU; and transmitting the masked FD-A-PPDU.

According to an embodiment of the present invention, a wireless communication device is provided, wherein the wireless communication device comprises a wireless transceiver circuit and a processor, and a DL FD-A-PPDU at least comprises a first PPDU and a second PPDU. The processor is arranged to perform a FD mask coefficient setting operation upon at least one field comprised in the first PPDU and at least one field comprised in the second PPDU according to a frequency sub-block in a frequency band used for transmitting the DL FD-A-PPDU, in order to generate a masked FD-A-PPDU, wherein the at least one field comprised in the first PPDU corresponds to the at least one field comprised in the second PPDU. The wireless transceiver circuit is coupled to the processor, and is arranged to transmit the masked FD-A-PPDU.

According to an embodiment of the present invention, a method for transmitting a trigger frame is provided. The method comprises: generating a trigger frame for triggering transmission of a UL PPDU, wherein the trigger frame comprises a common information field, at least one special user information field, and multiple user information fields; the common information field comprises a High Efficiency (HE)/non HE P160 field; and the HE/non HE P160 field is used for indicating whether a PPDU in P160 is a HE PPDU; and transmitting the trigger frame.

According to an embodiment of the present invention, a method for transmitting a UL PPDU is provided. The method comprises: receiving a trigger frame, wherein the trigger frame comprises a common information field, at least one special user information field, and multiple user information fields; the common information field comprises a High Efficiency (HE)/non HE P160 field; and the HE/non HE P160 field is used for indicating whether a PPDU in P160 is a HE PPDU; and according to a physical (PHY) version identifier in the at least one special user information field and the HE/non HE P160 field, transmitting the a PPDU.

One of the benefits of the present invention is that, by the methods and associated wireless communication devices of the present invention, a FD mask coefficient setting operation can be performed upon a DL FD-A-PPDU for reducing a PAPR of the DL FD-APPDU. In addition, for a case where a UL PPDU is transmitted, design flexibility of a Wi-Fi 8 generation or beyond Wi-Fi generations can be greatly improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating two wireless communication devices according to an embodiment of the present invention.

FIG. 2 is a diagram illustrating a format example of an FD-A-PPDU according to an embodiment of the present invention.

FIG. 3 is a diagram illustrating a wireless communication device according to an embodiment of the present invention.

FIG. 4 is a flow chart of a method for transmitting a DL FD-A-PPDU according to an embodiment of the present invention.

FIG. 5 is a diagram illustrating a simulation result of a first example of an FD mask coefficient setting operation according to an embodiment of the present invention.

FIG. 6 is a diagram illustrating a simulation result of a second example of an FD mask coefficient setting operation according to an embodiment of the present invention.

FIG. 7 is a diagram illustrating a simulation result of a third example of an FD mask coefficient setting operation according to an embodiment of the present invention.

FIG. 8 is a diagram illustrating reused FD mask coefficient values according to an embodiment of the present invention.

FIG. 9 is a diagram illustrating a wireless communication device according to an embodiment of the present invention.

FIG. 10 is a flow chart of a method for transmitting a trigger frame according to an embodiment of the present invention.

FIG. 11 is a diagram illustrating a wireless communication device according to an embodiment of the present invention.

FIG. 12 is a flow chart of a method for transmitting a UL PPDU according to an embodiment of the present invention.

FIG. 13 is a diagram illustrating a common information field of a trigger frame according to an embodiment of the present invention.

FIG. 14 is a diagram illustrating a special user information field of a trigger frame according to an embodiment of the present invention.

FIG. 15 is a diagram illustrating a first example of interpreting a trigger frame with aid of a 1-bit indicator in a common information field and a PHY version identifier in a special user information field according to an embodiment of the present invention.

FIG. 16 is a diagram illustrating a second example of interpreting a trigger frame with aid of a 1-bit indicator in a common information field and a PHY version identifier in a special user information field according to an embodiment of the present invention.

FIG. 17 is a diagram illustrating a trigger frame with two special user information fields according to an embodiment of the present invention.

FIG. 18 is a diagram illustrating a first example of a transmission order of multiple special user information fields and multiple user information fields included in a trigger frame according to an embodiment of the present invention.

FIG. 19 is a diagram illustrating a second example of a transmission order of a special user information field and multiple user information fields included in a trigger frame according to an embodiment of the present invention.

FIG. 20 is a diagram illustrating a third example of a transmission order of a special user information field and multiple user information fields included in a trigger frame according to an embodiment of the present invention.

FIG. 21 is a diagram illustrating a fourth example of a transmission order of multiple special user information fields and multiple user information fields included in a trigger frame according to an embodiment of the present invention.

FIG. 22 is a diagram illustrating a fifth example of a transmission order of multiple special user information fields and multiple user information fields included in a trigger frame according to an embodiment of the present invention.

FIG. 23 is a diagram illustrating a sixth example of a transmission order of a special user information field and multiple user information fields included in a trigger frame according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

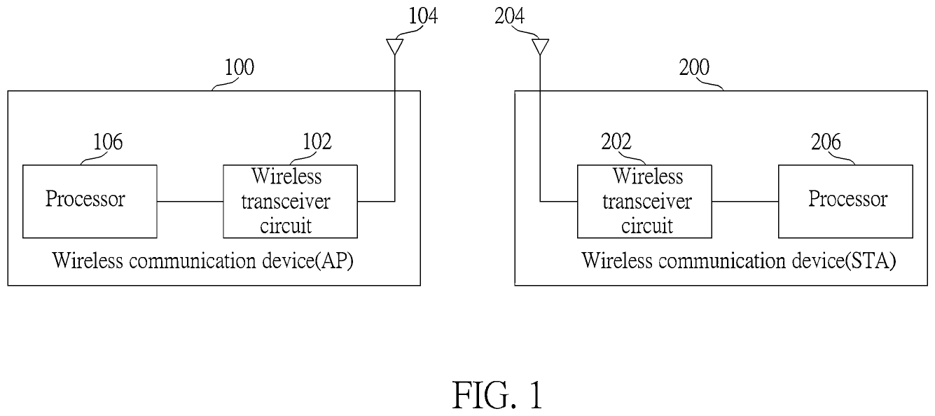

FIG. 1 is a diagram illustrating two wireless communication devices 100 and 200 according to an embodiment of the present invention. Both the wireless communication devices 100 and 200 may operate according to communication protocols specified by IEEE 802.11 standards. Each of the wireless communication devices 100 and 200 may be implemented as an access point (AP) or a station (STA), depending upon actual design requirements. In this embodiment, assume that the wireless communication device 100 is implemented as the AP, and the wireless communication device 200 is implemented as the STA. As shown in FIG. 1, the wireless communication device 100 may include a wireless transceiver circuit 102, an antenna 104, and a processor 106. Similarly, the wireless communication device 200 may include a wireless transceiver circuit 202, an antenna 204, and a processor 206.

The wireless transceiver circuit 102 may transmit a downlink (DL) frequency-domain aggregation physical layer protocol data unit (FD-A-PPDU) to the wireless communication device 200 via the antenna 104, wherein the DL FD-A-PPDU may include multiple PPDUS corresponding to the same or different Wireless Fidelity (Wi-Fi) generations.

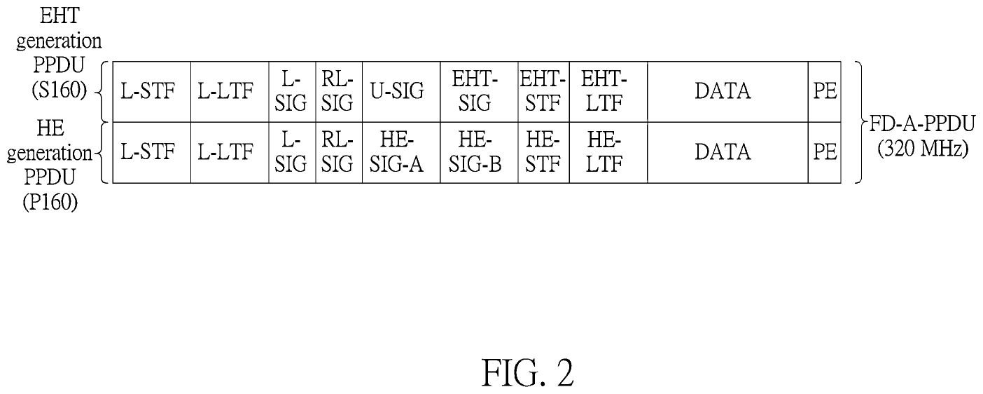

FIG. 2 is a diagram illustrating a format example of an FD-A-PPDU according to an embodiment of the present invention. In this embodiment, an AP (e.g., the wireless communication device 100) has a channel with 320 MHz, and may transmit a FD-A-PPDU to at least one non-AP STA through the 320 MHz channel, wherein the 320 MHZ channel may be divided into a primary channel with 160 MHZ (P160) and a secondary channel with 160 MHZ (S160). Assume that the FD-A-PPDU includes a Wi-Fi 6 generation PPDU (e.g., a High Efficiency (HE) generation PPDU) and a Wi-Fi 7 generation PPDU (e.g., an Extremely High Throughput (EHT) generation PPDU). The HE generation PPDU may be transmitted to a station corresponding to the HE generation via the P160, and the EHT generation PPDU may be transmitted to a station corresponding to the EHT generation via the S160.

As shown in FIG. 2, the EHT generation PPDU may include multiple fields, including a legacy preamble field, a signal field (SIG), a short training field (STF; labeled as “EHT-STF”), a long training field (LTF; labeled as “EHT-LTF”), a data field (labeled as “DATA”), and a packet extension (PE) field (labeled as “PE”), wherein the legacy preamble field may include a L-STF, a L-LTF, a L-SIG, and a repetition of the L-SIG field (labeled as “RL-SIG”); and the SIG field may include a universal SIG field (labeled as “U-SIG”) with a PHY version indicator for indicating the EHT generation, and an EHT SIG field (labeled as “EHT-SIG”).

Similarly, the HE generation PPDU may include multiple fields, including a legacy preamble field, a SIG, a STF (labeled as “HE-STF”), a LTF (labeled as “HE-LTF”), a data field (labeled as “DATA”), and a PE field (labeled as “PE”), wherein the legacy preamble field may include a L-STF, a L-LTF, a L-SIG, and a repetition of the L-SIG field (labeled as “RL-SIG”); and the SIG field may include a first HE SIG field (labeled as “HE-SIG-A”), and a second HE SIG field (labeled as “HE-SIG-B”).

For the above-mentioned two PPDUs, the fields therein may have a sequence pre-defined in the standard. Some specific fields can be reused between two different Wi-Fi generations. For example, the STF and the LTF can be reused between the HE generation PPDU and the EHT generation PPDU under the same PPDU bandwidth. Due to the duplicated sequence, a peak-to-average ratio (PAPR) of the DL FD-A-PPDU may increase.

In order to address this issue, a frequency-domain (FD) mask coefficient setting operation may be performed upon the DL FD-A-PPDU according to a frequency sub-block in order to generate a masked FD-A-PPDU, and then the masked FD-A-PPDU may be transmitted to at least one non-AP STA.

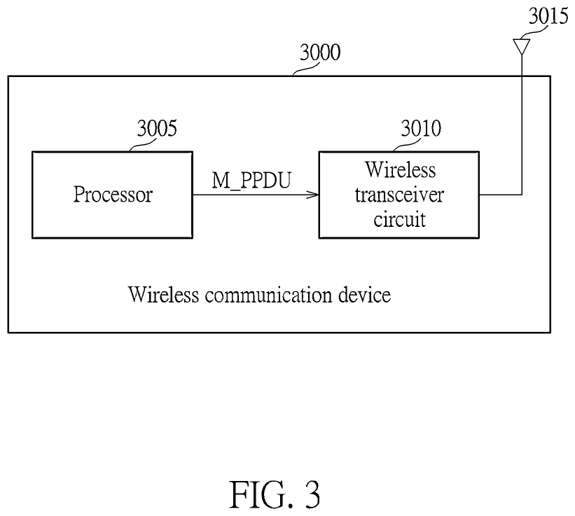

FIG. 3 is a diagram illustrating a wireless communication device 3000 according to an embodiment of the present invention, wherein the wireless communication devices 100 shown in FIG. 1 may be implemented by the wireless communication device 3000 (i.e., the wireless communication device 3000 may be an AP), and the wireless communication device 3000 may include a processor 3005, a wireless transceiver circuit 3010, and an antenna 3015. Assume that a DL FD-A-PPDU at least includes a first PPDU and a second PPDU. The processor 3005 may be arranged to perform a FD mask coefficient setting operation upon at least one field included in the first PPDU and at least one field included in the second PPDU according to a frequency sub-block in a frequency band used for transmitting the DL FD-A-PPDU, in order to generate a masked FD-A-PPDU (labeled as “M PPDU” in FIG. 3), wherein the at least one field included in the first PPDU corresponds to the at least one field included in the second PPDU. The wireless transceiver circuit 3010 may be coupled to the processor 3005, and may be arranged to transmit the masked FD-A-PPDU to at least one non-AP STA (e.g., the wireless communication device 200 shown in FIG. 1) via the antenna 3015, wherein the FD mask applied to the DL FD-A-PPDU may be transparent to a receiving side (i.e., the wireless communication device 200).

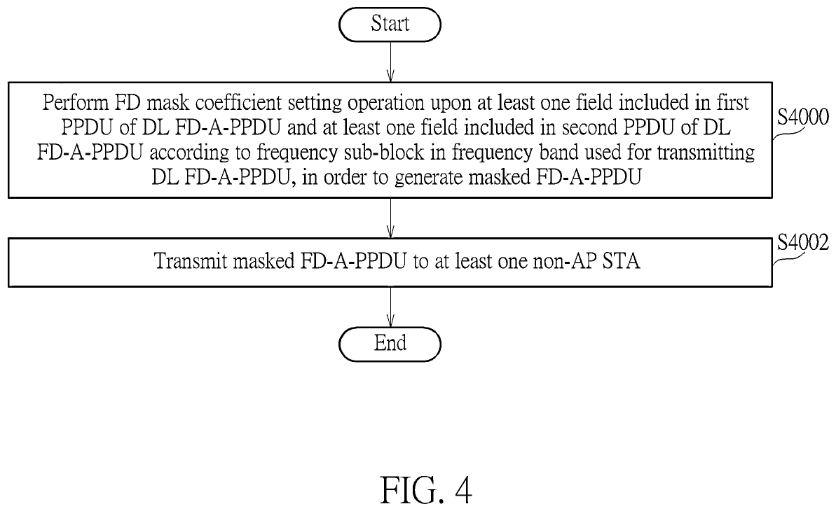

FIG. 4 is a flow chart of a method for transmitting a DL FD-A-PPDU according to an embodiment of the present invention, wherein the DL FD-A-PPDU at least includes a first PPDU and a second PPDU. Provided that the result is substantially the same, the steps are not required to be executed in the exact order shown in FIG. 4. For example, the method shown in FIG. 4 may be employed by the wireless communication device 3000 shown in FIG. 3. For better comprehension, the method may be illustrated with the flow shown in FIG. 4, but the present invention is not limited thereto. According to some embodiments, one or more steps may be added, deleted, or changed in the flow shown in FIG. 4.

In Step S4000, a FD mask coefficient setting operation is performed upon at least one field included in the first PPDU and at least one field included in the second PPDU according to a frequency sub-block in a frequency band used for transmitting the DL FD-A-PPDU, in order to generate a masked FD-A-PPDU, wherein the at least one field included in the first PPDU corresponds to the at least one field included in the second PPDU.

In some embodiments, the frequency band comprises a first channel for transmitting the first PPDU and a second channel for transmitting the second PPDU; the first channel comprises a plurality of first sub-blocks; the second channel comprises a plurality of second sub-blocks; mask coefficients of a sequence transmitted by at least one first sub-block among the plurality of first sub-blocks are opposite to mask coefficients of a sequence transmitted by at least one second sub-block among the plurality of second sub-blocks; and the at least one first sub-block corresponds to the at least one second sub-block.

In Step S4002, the masked FD-A-PPDU is transmitted to at least one non-AP STA.

Specifically, a unit of the frequency sub-block may be a multiple of 20 MHz, including 20 MHZ, 40 MHZ, 80 MHZ, and 160 MHZ. That is, the processor 3005 may perform the FD mask coefficient setting operation upon the FD-A-PPDU per 20 MHz, 40 MHZ, 80 MHz and/or 160 MHz, depending upon actual design requirements. In some embodiments, a unit of the frequency sub-block is equal to a bandwidth of a PPDU included in the FD-A-PPDU. In a case where the AP transmits different Wi-Fi generation PPDUs to corresponding STAs via two 160 MHz channels, the FD mask coefficient setting operation may be performed upon the FD-A-PPDU in units of 160 MHz. In some embodiments, FD mask coefficient can be different among the PPDUs; however, within the applied PPDU bandwidth, M times of 80 MHz subblock, FD mask coefficient is the same.

It should be noted that, the FD mask coefficient setting operation may be applied to different fields included in the PPDU. For example, the FD mask coefficient setting operation may be performed upon the legacy preamble field and the SIG, i.e., before the STF (e.g., a HE/EHT/UHR/UHR⁺ STF), but the present invention is not limited thereto. In some embodiments, the FD mask coefficient setting operation may be performed upon the HE/EHT/UHR/UHR⁺ STF, the LTF, and the data field. In some embodiments, the FD mask coefficient setting operation may be performed upon each of the legacy preamble field, the HE/EHT/UHR/UHR⁺ SIG, the STF, the LTF, and the data field.

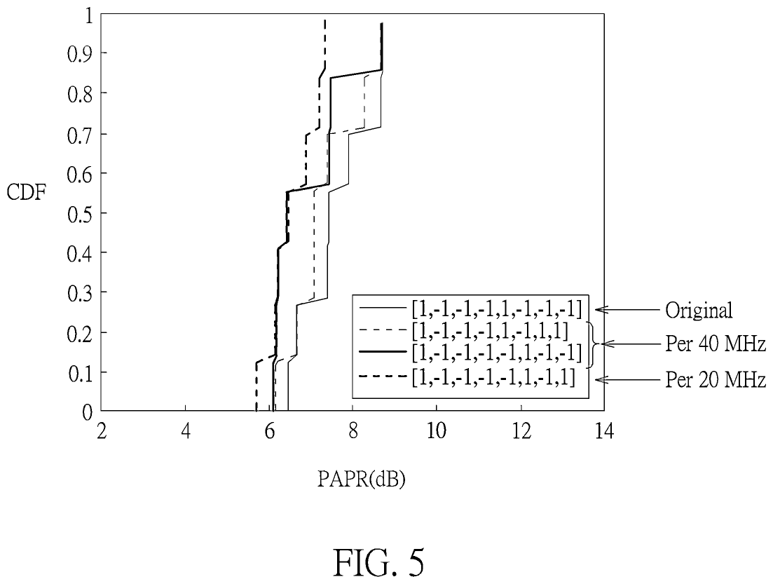

FIG. 5 is a diagram illustrating a simulation result of a first example of an FD mask coefficient setting operation according to an embodiment of the present invention, wherein the diagram has a horizontal axis showing a PAPR in units of decibel (dB) and a vertical axis showing a corresponding cumulative distribution function (CDF). In this embodiment, assume that the FD-A-PPDU is transmitted via a 160 MHz channel including a primary channel with 80 MHZ (P80) and a secondary channel with 80 MHZ (S80), the P80 is used for transmitting a first PPDU, the S80 is used for transmitting a second PPDU, an original FD mask coefficient value of the FD-A-PPDU, which includes the coefficients in the current standard for each PPDU, is [1, −1, −1, −1, 1, −1, −1, −1], the first four values of [1, −1, −1, −1, 1, −1, −1, −1] may correspond to P80, and the last four values of [1, −1, −1, −1, 1, −1, −1, −1] may correspond to S80. The FD mask coefficient setting operation is performed upon the L-LTF of the FD-A-PPDU per 20 MHz or 40 MHz. Under a case where the FD mask coefficient setting operation is performed per 20 MHz, the FD mask coefficient value [1, −1, −1, −1, 1, −1, −1, −1] may be optimized to [1, −1, −1, −1, −1, 1, −1, 1], wherein each value in eight values is applied to a 20 MHz L-LTF sequence of the FD-A-PPDU. The mask coefficients of at least one 20 MHz L-LTF sequence in S80 are opposite to those of the corresponding 20 MHZ L-LTF sequence in P80 corresponding to the at least one 20 MHz L-LTF sequence in S80. As shown in FIG. 5, the first, second and fourth values in the last four values of [1, −1, −1, −1, −1, 1, −1, 1] are opposite to the first, second and fourth values in the first four values of [1, −1, −1, −1, −1, 1, −1, 1]. Under a case where the FD mask coefficient setting operation is performed per 40 MHz, the FD mask coefficient value [1, −1, −1, −1, 1, −1, −1, −1] may be optimized to [1, −1, −1, −1, 1, −1, 1, 1] or [1, −1, −1, −1, −1, 1, −1, −1]. The mask coefficients of at least one 40 MHz L-LTF sequence in S80 are opposite to mask coefficients of the corresponding 40 MHZ L-LTF sequence in P80 corresponding to the at least one 40 MHZ L-LTF sequence in S80. As shown in FIG. 5, the third and fourth values in the last four values of [1, −1, −1, −1, 1, −1, 1, 1] are opposite to the third and fourth values in the first four values of [1, −1, −1, −1, 1, −1, 1, 1], and the first and second values in the last four values of [1, −1, −1, −1, −1, 1, −1, −1] are opposite to the first and second values in the first four values of [1, −1, −1, −1, −1, 1, −1, −1].

Compared with the PAPR corresponding to the original FD mask coefficient, the FD mask coefficient setting operation performed upon the FD-A-PPDU per 20 MHz or 40 MHz can significantly reduce the PAPR because the mask coefficients of one or more 20 L-LTF sequences (or one or more 40 MHz L-LTF sequences) in S80 are opposite to those of corresponding one or more 20 L-LTF sequences (or one or more 40 MHz L-LTF sequences) in P80.

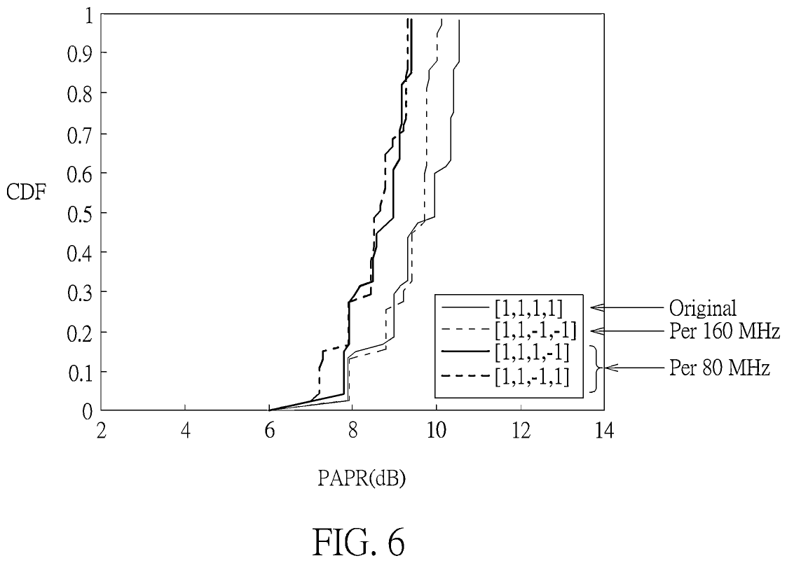

FIG. 6 is a diagram illustrating a simulation result of a second example of an FD mask coefficient setting operation according to an embodiment of the present invention, wherein the diagram has a horizontal axis showing a PAPR in units of dB and a vertical axis showing a corresponding CDF. In this embodiment, assume that the FD-A-PPDU is transmitted via a 320 MHz channel including P160 and S160, a HE generation PPDU included in the FD-A-PPDU may correspond to the P160, the S160 is used for transmitting a second PPDU, an original FD mask coefficient value of the FD-A-PPDU, which includes the coefficients in the current standard for each PPDU, is [1, 1, 1, 1]. The first two values of [1, 1, 1, 1] may correspond to the P160, and the last two values of [1, 1, 1, 1] may correspond to the S160. For example, the first two values of [1, 1, 1, 1] represents that the 4x HE-LTF of 160 MHZ sequence is {LTF80MHz_sublock_left_4x, zero (1, 5), LTF80MHz_subblock_right_4x, zero (1, 23), LTF80MHz_subblock_left_4x, zero (1, 5),-LTF80MHz_subblock _right_4x}, which is defined in the current standard. The FD mask coefficient setting operation is performed upon the HE-LTF 160 MHZ sequence and the EHT-LTF 160 MHz sequence of the FD-A-PPDU per 80 MHZ or 160 MHz. The mask parameters are applied to the HE-LTF 160 MHZ sequence and EHT-LTF 160 MHz sequence. In an alternative embodiment, the same mask parameters are applied to the legacy preamble field, the STF, the LTF, and the data field.

Under a case where the FD mask coefficient setting operation is performed per 80 MHz, the FD mask coefficient value [1, 1, 1, 1] may be optimized to [1, 1, 1, −1] or [1, 1, −1, 1]. The mask coefficients of one or more 80 MHZ EHT-LTF sequences in the S160 are opposite to those of corresponding one or more 80 MHZ HE-LTF sequences in the P160. As shown in FIG. 6, the second value in the last two values of [1, 1, 1, −1] are opposite to the second value in the first two values of [1, 1, 1, −1]. For example, the masked P160 LTF sequence is HE-LTF 160 MHz 4x, and the masked S160 LTF sequence is {LTF80MHz_sublock_left_4x, zero (1, 5), LTF80 MHZ_subblock_right_4, zero (1, 23),-LTF80MHZ_subblock_left_4x, zero (1, 5), LTF80MHz _subblock_right_4x}. In an alternative embodiment, the first value in the last two values of [1, 1, −1, 1] are opposite to the first value in the first two values of [1, 1, −1, 1].

Under a case where the FD mask coefficient setting operation is performed per 160 MHz, the FD mask coefficient value [1, 1, 1, 1] may be optimized to [1, 1, −1, −1]. The mask coefficients of 160 MHZ EHT-LTF sequence in S160 are opposite to those of corresponding 160 MHZ HE-LTF sequence in P160. As shown in FIG. 6, the first and second values in the last two values of [1, 1, −1, −1] are opposite to the first and second values in the first two values of [1, 1, −1, −1]. For example, the masked P160 LTF sequence is HE-LTF_160MHZ_4x, and the masked S160 LTF sequence is-HE-LTF_160 MHz_4x.

In alternative embodiment, the FD mask coefficient setting operation is performed according to a frequency sub-block with a unit equal to the PPDU bandwidth. In this embodiment, since a bandwidth of a PPDU included in the FD-A-PPDU is 160 MHZ, the FD mask coefficient setting operation may be performed according to a frequency sub-block with a unit equal to 160 MHZ.

As shown in FIG. 6, compared with the PAPR corresponding to the original FD mask coefficient, the FD mask coefficient setting operation performed upon the FD-A-PPDU per 80 MHz or 160 MHz can significantly reduce the PAPR.

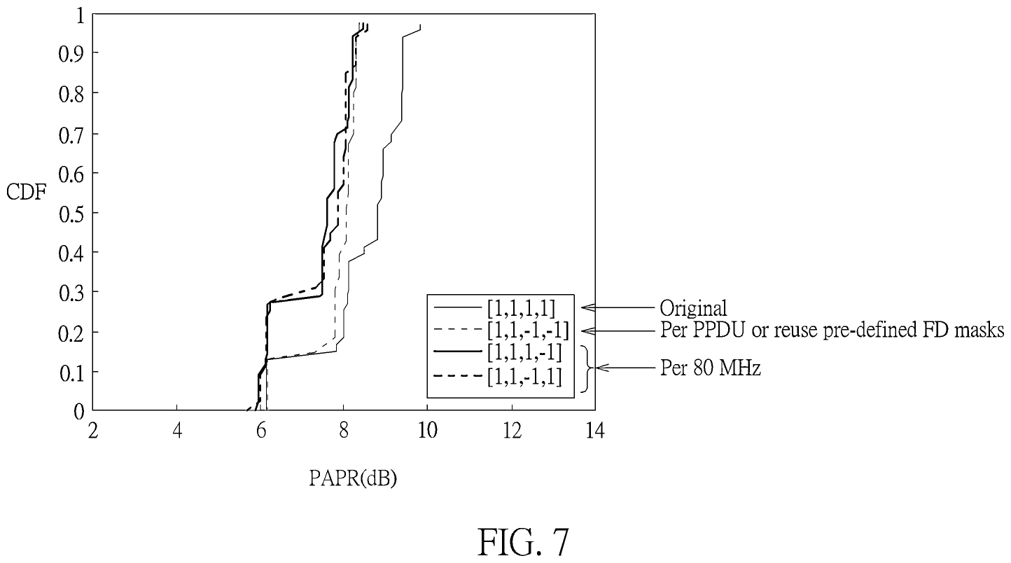

FIG. 7 is a diagram illustrating a simulation result of a third example of an FD mask coefficient setting operation according to an embodiment of the present invention, wherein the diagram has a horizontal axis showing a PAPR in units of dB and a vertical axis showing a corresponding CDF. In this embodiment, assume that the FD-A-PPDU is transmitted via a 320 MHz channel including P160 and S160, an EHT generation PPDU included in the FD-A-PPDU may correspond to the P160, an original FD mask coefficient value of the FD-A-PPDU, which includes the coefficients in the current standard for each PPDU, is [1, 1, 1, 1], the first two values of [1, 1, 1, 1] may correspond to the P160, and the last two values of [1, 1, 1, 1] may correspond to the S160. The FD mask coefficient setting operation is performed upon the P160 LTF sequence and the S160 LTF sequence of the FD-A-PPDU per 80 MHz or based on the bandwidth of a PPDU included in the FD-A-PPDU.

Under a case where the FD mask coefficient setting operation is performed per 80 MHz, the FD mask coefficient value [1, 1, 1, 1] may be optimized to [1, 1, 1, −1] or [1, 1, −1, 1]. Under a case where the FD mask coefficient setting operation is performed according to a frequency sub-block with a unit equal to the PPDU bandwidth (i.e., 160 MHz), the FD mask coefficient value [1, 1, 1, 1] may be optimized to [1, 1, −1, −1]. The first and second values in the last two values of [1, 1, −1, −1] are opposite to the first and second values in the first two values of [1, 1, −1, −1].

In addition, in this embodiment, since mask coefficient values for single 320 MHZ EHT PPDU are defined in EHT. For a 320 MHz FD-A-PPDU, if EHT and UHR are combined in the 320 MHZ FD-A-PPDU, the mask coefficient values for single 320 MHZ EHT PPDU may be reused for the 320 MHZ FD-A-PPDU. As shown in FIG. 7, a predefined FD mask coefficient values [1, 1, −1, −1] for single 320 MHZ EHT PPDU may be reused for the 320 MHZ FD-A-PPDU.

As shown in FIG. 7, compared with the PAPR corresponding to the original FD mask coefficient, the above-mentioned FD mask coefficient setting operation can significantly reduce the PAPR.

A predefined FD mask coefficient values for single PPDU may be reused for a FD-A-PPDU, wherein the single PPDU and the FD-A-PPDU have the same bandwidth.

Since mask coefficient values for 80+80 PPDU or 160 MHz PPDU are defined in HE and EHT, for a 160 MHZ FD-A-PPDU, mask coefficient values for 80+80 PPDU or 160 MHz PPDU may be reused for the 160 MHz FD-A-PPDU. For example, the lower 80 MHz is the P80 and the higher 80 MHz is the S80. Then, the following masked sequence for 80+80 PPDU may be reused for the 160 MHz FD-A-PPDU:
1x STF: [M, 1,−M, 0,−M, 1,−M] and [−M, −1, M, 0,−M, 1,−M]; 4x LTF:
LTF80MHz_lower_4x={LTF80MHz_left_4x, 0, LTF80MHz_right_4x};
LTF80MHz_upper_4x={LTF80MHz_left_4x, 0,-LTF80MHz_right_4x};

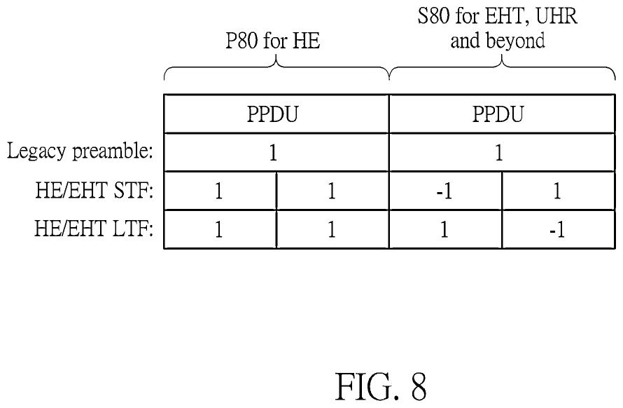

FIG. 8 is a diagram illustrating reused FD mask coefficient values according to an embodiment of the present invention. Since mask coefficient values for single 320 MHZ EHT PPDU are defined in EHT, for a 320 MHZ FD-A-PPDU, the mask coefficient values for single 320 MHZ EHT PPDU may be reused for the 320 MHZ FD-A-PPDU.

Based on the above embodiments, exemplary mask coefficients for other bandwidth are shown below:
FD-A-PPDU 240 MHZ=[c (1) *80 MHz_subblock, c (2)*80 MHz_subblock, c (3)* 80 MHz_subblock]. For example, mask coefficient values C=[1, 1, −1], [−1, −1, 1], etc.
FD-A-PPDU_320_MHz=[c (1)*80 MHz_subblock, c (2)* 80 MHz_subblock, c (3)*80 MHz_subblock, c (4)*80 MHz_subblock]. For example, C=[1,1, 1, −1], [1,1, −1, −1], etc.
FD-A-PPDU_480 MHZ=[c (1)*80 MHz_subblock, c (2)* 80 MHz_subblock, c (3)*80 MHZ_subblock, c (4)*80 MHz_subblock, c (5)* 80 MHz_subblock, c (6)* 80 MHz_subblock]. For example, C=[1,1, −1, −1, −1, −1], [1, 1, 1, −1, −1,1], etc.
FD-A-PPDU_640 MHZ=[c (1)*80 MHz_subblock, c (2)*80 MHz_subblock, c (3)* 80 MHz_subblock, c (4)* 80 MHZ_subblock, c (5)* 80MHz_subblock, c (6)*80 MHz_subblock, c (7)*80 MHz_subblock, c (8)*80 MHz_subblock]. For example, C=[1, 1, 1, 1, −1, 1, −1,1], [1, 1, 1, −1, −1, −1, −1, 1], etc.

Under some situations, when an AP requires receiving an uplink (UL) PPDU from the non-AP STA (e.g., the wireless communication device 200), the AP may transmit a trigger frame to the non-AP STA for triggering transmission of the UL PPDU.

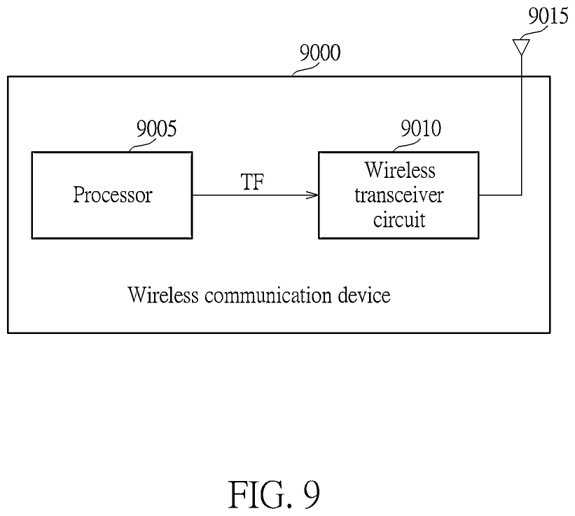

FIG. 9 is a diagram illustrating a wireless communication device 9000 according to an embodiment of the present invention, wherein the wireless communication devices 100 shown in FIG. 1 may be implemented by the wireless communication device 9000 (i.e., the wireless communication device 900 may be an AP), and the wireless communication device 9000 may include a processor 9005, a wireless transceiver circuit 9010, and an antenna 9015. The processor 9005 may be arranged to generate a trigger frame (labeled as “TF” in FIG. 9) for triggering transmission of a UL PPDU, wherein the trigger frame may include a common information field, at least one special user information field, and multiple user information fields; the common information field includes a HE/non HE P160 field; and the HE/non HE P160 field is used for indicating whether a PPDU in P160 is a HE PPDU. The wireless transceiver circuit 9010 may be coupled to the processor 9005, and may be arranged to transmit the trigger frame to at least one STA (e.g., the wireless communication device 200 shown in FIG. 1) via the antenna 9015.

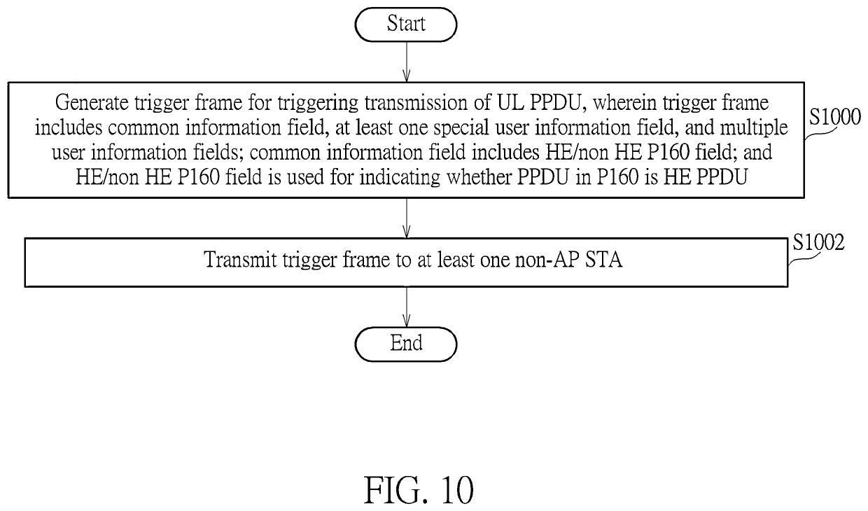

FIG. 10 is a flow chart of a method for transmitting a trigger frame according to an embodiment of the present invention. Provided that the result is substantially the same, the steps are not required to be executed in the exact order shown in FIG. 10. For example, the method shown in FIG. 10 may be employed by the wireless communication device 900 shown in FIG. 9. For better comprehension, the method may be illustrated with the flow shown in FIG. 10, but the present invention is not limited thereto. According to some embodiments, one or more steps may be added, deleted, or changed in the flow shown in FIG. 10.

In Step S1000, a trigger frame is generated for triggering transmission of a UL PPDU, wherein the trigger frame includes a common information field, at least one special user information field, and multiple user information fields; the common information field includes a HE/non HE P160 field; and the HE/non HE P160 field is used for indicating whether a PPDU in P160 is a HE PPDU.

In Step S1002, the trigger frame is transmitted to at least one non-AP STA.

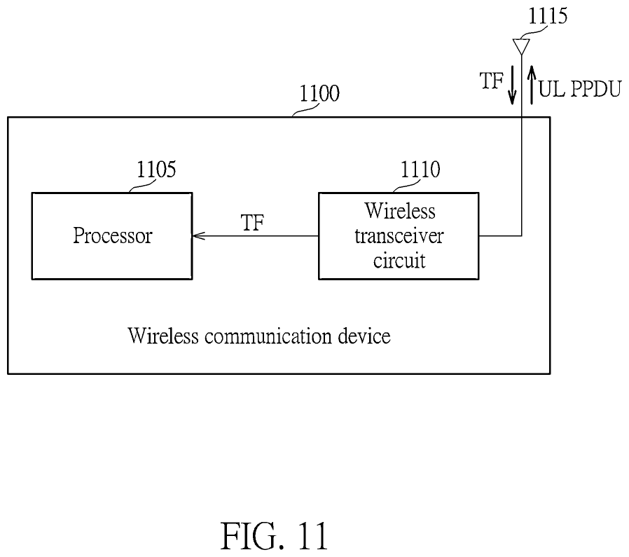

FIG. 11 is a diagram illustrating a wireless communication device 1100 according to an embodiment of the present invention, wherein the wireless communication devices 200 shown in FIG. 1 may be implemented by the wireless communication device 1100 (i.e., the wireless communication device 1100 may be a non-AP STA), and the wireless communication device 1100 may include a processor 1105, a wireless transceiver circuit 1110, and an antenna 1115. The wireless transceiver circuit 1110 may be arranged to receive a trigger frame for triggering transmission of a UL PPDU via the antenna 1115, wherein the trigger frame may include a common information field, at least one special user information field, and multiple user information fields; the common information field may include a HE/non HE P160 field; and the HE/non HE P160 field is used for indicating whether a PPDU in P160 is a HE PPDU. The processor 1105 may be coupled to the wireless transceiver circuit 1110, and may be arranged to transmitting a UL PPDU via the wireless transceiver circuit 1110 and the antenna 1115 according to a PHY version identifier in the at least one special user information field and the HE/non HE P160 field. A PHY version of the UL PPDU is determined based on the PHY version identifier in one special user information field, and when the HE/non HE P160 field indicates that the PPDU in P160 is not the HE PPDU, the UL PPDU with PHY version is transmitted on P160. For example, an UHR STA interprets that the HE/non HE P160 field indicates the PPDU in P160 is not the HE PPDU. The UHR STA determines UHR version based on the PHY version identifier in one special user information field. So, the UHR STA transmits the UL PPDU on P160.

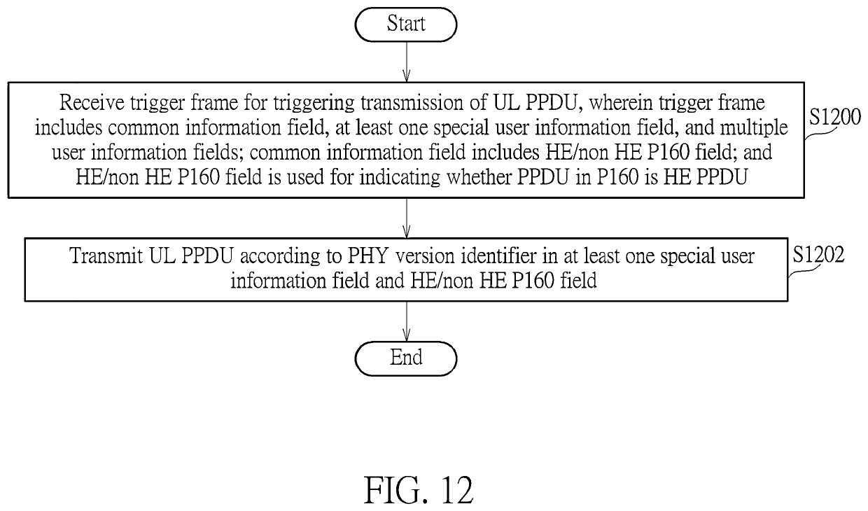

FIG. 12 is a flow chart of a method for transmitting a UL PPDU according to an embodiment of the present invention. Provided that the result is substantially the same, the steps are not required to be executed in the exact order shown in FIG. 12. For example, the method shown in FIG. 12 may be employed by the wireless communication device 1100 shown in FIG. 11. For better comprehension, the method may be illustrated with the flow shown in FIG. 12, but the present invention is not limited thereto. According to some embodiments, one or more steps may be added, deleted, or changed in the flow shown in FIG. 12.

In Step S1200, a trigger frame for triggering transmission of a UL PPDU is received, wherein the trigger frame includes a common information field, at least one special user information field, and multiple user information fields; the common information field includes a HE/non HE P160 field; and the HE/non HE P160 field is used for indicating whether a PPDU in P160 is a HE PPDU.

In Step S1202, the UL PPDU is transmitted according to a PHY version identifier in the at least one special user information field and the HE/non HE P160 field.

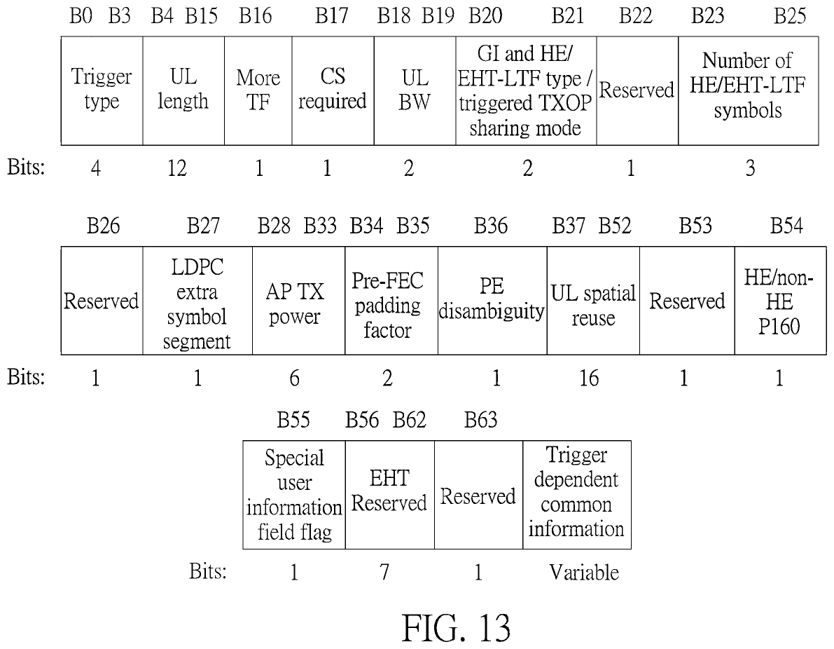

FIG. 13 is a diagram illustrating a common information field of a trigger frame according to an embodiment of the present invention. As shown in FIG. 13, the common information field of the trigger frame may include a trigger type field (BO-B3), a UL length field (B4-B15), a more trigger frame (TF) field (B16), a carrier sensing (CS) required field (B17), a UL bandwidth (BW) field (B18-B19), a guard interval (GI) and HE/EHT-LTF type/triggered transmission opportunity y (TXOP) sharing mode field (B20-B21), a number of HE/EHT-LTF symbols field (B23-B25), a low-density parity-check (LDPC) extra symbol segment field (B27), an AP transmission (TX) power field (B28-B33), a pre-forward error coding (FEC) padding factor field (B34-B35), a PE disambiguity field (B36), a UL spatial reuse field (B37-B52), a HE/non-HE P160 field (B54), a special user information field flag field (B55), multiple EHT reserved fields (B56-B62), multiple reserved fields (B22, B26, B53, and B63), and a trigger dependent common information field.

For an existing common information field of the trigger frame, the field corresponding to B54 may be a HE/EHT P160 field which indicates whether a solicited trigger-based (TB) PPDU in the P160 is an EHT TB PPDU or a HE TB PPDU. In response to the HE/EHT P160 field being set to 0, it is indicated that the solicited TB PPDU in the P160 is an EHT TB PPDU. In response to the HE/EHT P160 field being set to 1, it is indicated that the solicited TB PPDU in the P160 is a HE TB PPDU. The HE/EHT P160 field, however, restricts the granularity of the FD-A-PPDU and causes reduced design flexibility for a Wi-Fi 8 generation (e.g., an Ultra High Reliability (UHR) generation) or beyond Wi-Fi generations. As a result, in the present invention, the field corresponding to B54 is modified from the HE/EHT P160 field to the HE/non-HE P160 field, wherein the HE/non-HE P160 field may indicate whether the PPDU in the P160 is in a HE format.

Furthermore, a 1-bit indicator may be included in one of the reserved fields and the EHT reserved fields (i.e., may be one of B22, B26, B53, and B56-B63), and may be a FD-A-PPDU indicator for indicating whether the UL PPDU transmitted from the STA (e.g., the wireless communication device 200) is a FD-A-PPDU. After receiving the trigger frame, the wireless communication device 200 (more particularly, the processor 206 therein) may interpret the user information fields according to a physical (PHY) version identifier in the special user information field and the 1-bit indicator in the common information field in order to generate an interpreted result, and then transmit the UL PPDU to the AP (e.g., the wireless communication device 100) according to the interpreted result via the wireless transceiver circuit 102.

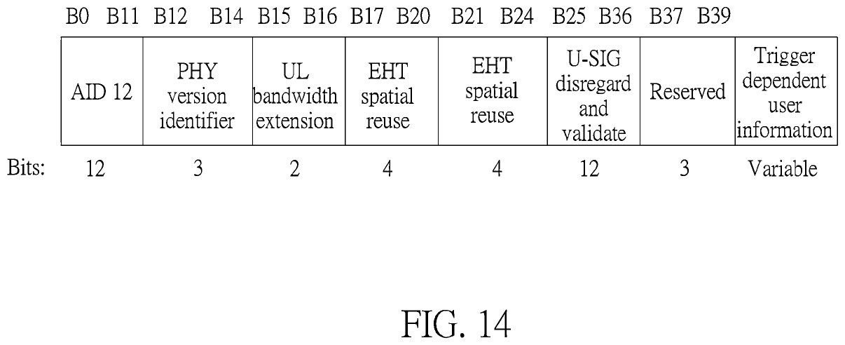

FIG. 14 is a diagram illustrating a special user information field of a trigger frame according to an embodiment of the present invention. As shown in FIG. 14, the special user information field of the trigger frame may include an association identifier (AID) 12 field (BO-B11), a PHY version identifier field (B12-B14), a UL bandwidth extension field (B15-B16), a first EHT spatial reuse field (B17-B20), a second EHT spatial reuse field (B21-B24), a universal signal (U-SIG) disregard and validate field (B25-B36), a reserved field (B37-B39), and a trigger dependent user information field. In a case where only one special user information field is applied to trigger STAs, if the STAs include an EHT non-AP STA and an UHR non-AP STA, 11bn feature signaling (e.g., a dynamic sub-band operation (DSO)) may be indicated by the U-SIG disregard and validate field and the reserved field for avoiding an interoperation issue in the FD-A-PPDU. In addition, in this case, a length of the special user information field is fixed. For example, the length of the special user information field can be maintained at 40 bits when the single special user information field is included in the trigger frame.

For a HE non-AP STA, the special user information field may be regarded as a normal user information field, and each user information field included in the trigger frame may be interpreted as a HE format.

For an EHT non-AP STA, in response to the special user information field with the PHY version identifier indicating an EHT version, each user information field may be interpreted as an EHT format. Otherwise, each user information field may be interpreted as the HE format.

For an UHR non-AP STA, the user information fields may be interpreted as an EHT format or an UHR format according to the 1-bit indicator in the common information field and the PHY version identifier in the special user information field. In response to the 1-bit indicator indicating that the UL PPDU is not the FD-A-PPDU and the PHY version identifier indicating the EHT version, each user information field may be interpreted as the EHT format. In response to the 1-bit indicator indicating that the UL PPDU is the FD-A-PPDU and the PHY version identifier indicating the EHT version, each user information field may be interpreted as an UHR format. In response to the 1-bit indicator indicating that the UL PPDU is not the FD-A-PPDU and the PHY version identifier indicating the UHR version, each user information field may be interpreted as the UHR format. In response to the 1-bit indicator indicating that the UL PPDU is the FD-A-PPDU and the PHY version identifier indicating the UHR version, each user information field may be interpreted as the UHR format. In addition, if the special user information field is not detected, the UHR non-AP STA may interpret each user information field as the HE format.

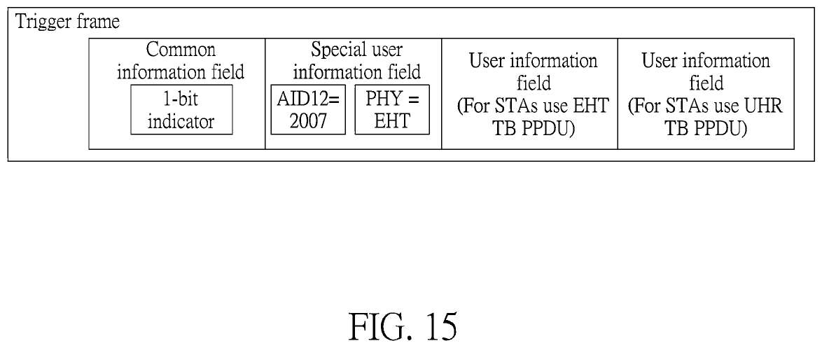

FIG. 15 is a diagram illustrating a first example of interpreting a trigger frame with aid of a 1-bit indicator in a common information field and a PHY version identifier in a special user information field according to an embodiment of the present invention. In this embodiment, assume that the 1-bit indicator indicates that the UL PPDU is a FD-A-PPDU, and the FD-A-PPDU includes an EHT generation PPDU and an UHR generation PPDU. The trigger frame includes a common information field, a special user information field, and at least two user information fields. For better comprehension, two user information fields are shown in FIG. 15, wherein one of the user information fields corresponds to an EHT non-AP STA, and another of the user information fields corresponds to an UHR non-AP STA. The AID12 field and the PHY version identifier in the special user information field are set as 2007 and the EHT version, respectively (labeled as “AID=2007” and “PHY=EHT” in FIG. 15). Since the current standard specifies that the special user information field with AID=2007 and PHY=EHT should be placed immediately after the common information field in the trigger frame, the special user information field with AID=2007 and PHY=EHT is transmitted immediately after the common information field, as shown in FIG. 15.

For an EHT non-AP STA, after the special user information field with the PHY version identifier indicating the EHT version and the AID12 field being 2007 is decoded, the EHT non-AP STA may interpret the following user information field as the EHT format.

For an UHR non-AP STA, after the special user information field with the PHY version identifier indicating the EHT version and the AID 12 field being 2007 is decoded, the UHR non-AP STA is further arranged to check the 1-bit indicator in the common information field. If the 1-bit indicator indicates that the UL PPDU is a FD-A-PPDU, the UHR non-AP STA may interpret user information fields as the UHR format. If the 1-bit indicator indicates that the UL PPDU is not an FD-A-PPDU, the UHR non-AP STA may interpret user information fields as the EHT format. It should be noted that, the user information fields respectively corresponding to the EHT non-AP STA and the UHR non-AP STA do not need a specific transmission order in the trigger frame.

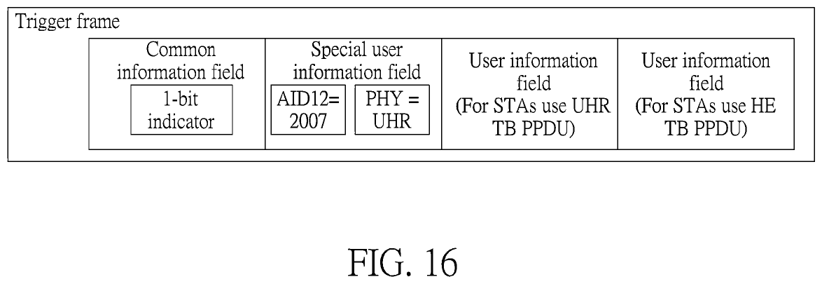

FIG. 16 is a diagram illustrating a second example of interpreting a trigger frame with aid of a 1-bit indicator in a common information field and a PHY version identifier in a special user information field according to an embodiment of the present invention. In this embodiment, assume that the 1-bit indicator indicates that the UL PPDU is a FD-A-PPDU, and the FD-A-PPDU includes a HE generation PPDU and an UHR generation PPDU. The trigger frame includes a common information field, a special user information field, and at least two user information fields. For better comprehension, two user information fields are shown in FIG. 16, wherein one of the user information fields corresponds to a HE non-AP STA, and another of the user information fields corresponds to an UHR non-AP STA. The AID12 field and the PHY version identifier in the special user information field are set as 2007 and the UHR version, respectively (labeled as “AID12=2007” and “PHY=UHR” in FIG. 16). As shown in FIG. 16, in the trigger frame, the special user information field is transmitted immediately after the common information field.

For a HE non-AP STA, it treats AID12=2007 as other HE's AID and treats the special user information field as a normal user information field to other HE non-AP STAs. It may interpret the following user information fields included in the trigger frame as the HE format.

For an UHR non-AP STA, after the special user information field with the PHY version identifier indicating the UHR version and the AID12 field being 2007 is decoded, the UHR non-AP STA may directly interpret user information fields as the UHR format without checking the 1-bit indicator in the common information field. It should be noted that, the user information fields respectively corresponding to the HE non-AP STA and the UHR non-AP STA do not need a specific transmission order in the trigger frame.

In some embodiments, the trigger frame may include more than one special user information fields, and the common information field of the trigger frame may include an indicator for indicating a number of the special user information fields. Take the common information field shown in FIG. 13 as an example. The indicator may be a 2-bit indicator, and may include a bit corresponding to the special user information field flag field (i.e., B55) and another bit corresponding to one of the reserved fields and the EHT reserved fields (i.e., one of B22, B26, B53, and B56-B63). For example, the 2-bit indicator may include B55 and B56. In response to both B55 and B56 being logical values “1”, the 2-bit indicator indicates that the number of special user information fields is zero. In response to B55 being a logical value “0” and B56 being a logical value “1”, the 2-bit indicator indicates that the number of special user information fields is one. In response to both B55 and B56 being logical values “0”, the 2-bit indicator indicates that the number of special user information fields is two, and is further arranged to explicitly indicate the UL PPDU is a FD-A-PPDU. For a case where B55 is a logical value “1” and B56 is a logical value “0”, the 2-bit indicator can be reserved in the UHR generation, or can be defined in beyond Wi-Fi generations (also referred to as UHR+).

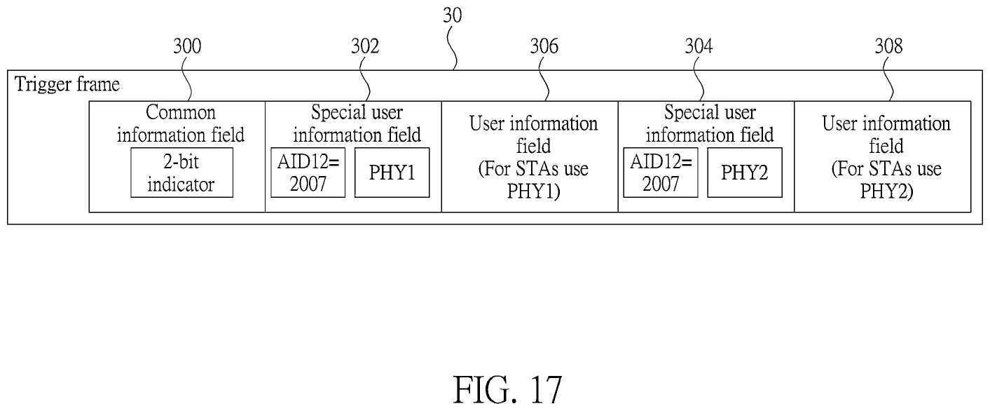

FIG. 17 is a diagram illustrating a trigger frame 30 with two special user information fields 302 and 304 according to an embodiment of the present invention, wherein the trigger frame 30 may be arranged to trigger transmission of a UL FD-A-PPDU. As shown in FIG. 17, the trigger frame 30 may include a common information field 300, two special user information fields 302 and 304, and at least two user information fields. For better comprehension, two user information fields 306 and 308 are shown in FIG. 17, wherein the user information field 306 corresponds to the special user information field 302, and the user information field 308 corresponds to the special user information field 304. The common information field 300 may include a 2-bit indicator, and the 2-bit indicator indicates that the number of special user information fields is two. The AID12 field and the PHY version identifier in the special user information field 302 are set as 2007 and a first PHY version, respectively (labeled as “AID12=2007” and “PHY1” in FIG. 17). The AID12 field and the PHY version identifier in the special user information field 304 are set as 2007 and a second PHY version, respectively (labeled as “AID12 =2007” and “PHY2” in FIG. 17), wherein the second PHY version may be different from the first PHY version.

In this embodiment, the user information field 306 is transmitted immediately after the special user information field 302, and the user information field 308 is transmitted immediately after the special user information field 304. As a result, each of the special user information fields 302 and 304 may serve as a delimiter for user information fields corresponding to different Wi-Fi generations. After receiving the trigger frame 30, the wireless communication device 200 (more particularly, the processor 206 therein) may interpret the user information fields 306 and 308 according to a PHY version identifier in each of the special user information fields 302 and 304 in order to generate an interpreted result, and then transmit a UL PPDU to the wireless communication device 100 according to the interpreted result via the transceiver circuit 202. For example, an EHT special user information field follows the common information field 300, EHT user information fields follow the EHT special user information field, an UHR special user information field follows the EHT user information fields, and UHR User Info fields follow the UHR special user information field.

In addition, if the PHY version identifier included in a special user information field indicates an EHT version, the special user information field is required to be transmitted immediately after the common information field 300. For example, if the first PHY version corresponding to the special user information field 302 is set as the EHT version, the special user information field 302 is required to be transmitted immediately after the common information field 300.

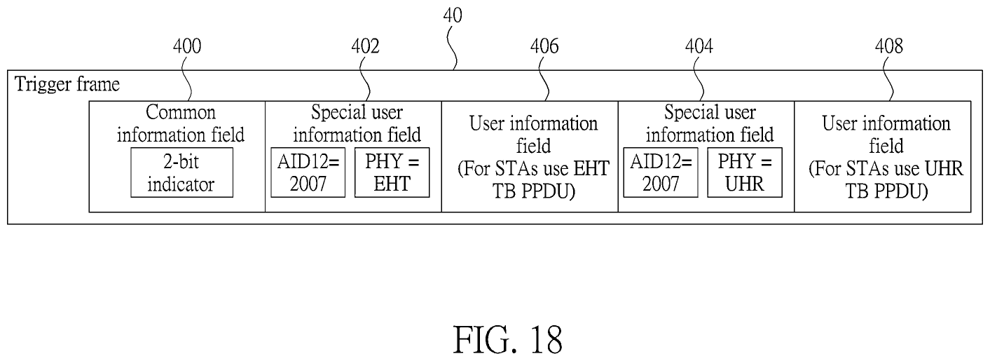

FIG. 18 is a diagram illustrating a first example of a transmission order of multiple special user information fields and multiple user information fields included in a trigger frame 40 according to an embodiment of the present invention, wherein the trigger frame 40 may be arranged to trigger transmission of a UL FD-A-PPDU, and the UL FD-A-PPDU includes an EHT generation PPDU and an UHR generation PPDU. In this embodiment, the trigger frame 40 includes a common information field 400, multiple special user information fields 402 and 404, and multiple user information fields 406 and 408, wherein the 2-bit indicator included in the common information field 400 indicates that the number of special user information fields is two; the user information field 406 corresponds to the special user information field 402, and is transmitted immediately after the special user information field 402; and the user information corresponds to the special user information field 404, and is transmitted immediately after the special user information field 404. The AID12 field and the PHY version identifier in the special user information field 402 are set as 2007 and the EHT version, respectively (labeled as “AID12=2007” and “PHY=EHT” in FIG. 18), and the special user information field 402 is required to be transmitted immediately after the common information field 400. The AID12 field and the PHY version identifier in the special user information field 404 are set as 2007 and the UHR version, respectively (labeled as “AID12=2007” and “PHY=UHR” in FIG. 18).

It should be noted that, in the trigger frame 40, the special user information field 402 with the PHY version identifier indicating the EHT version and the corresponding user information field 406 are required to be transmitted earlier than the special user information field 404 with the PHY version identifier indicating the UHR version and the corresponding user information field 408, in order to avoid unexpected behaviors of an EHT non-AP STA. In this embodiment, STAs using an EHT TB PPDU should be solicited earlier than STAs using an UHR TB PPDU.

For an EHT non-AP STA, when the special user information field 402 with the PHY version identifier indicating the EHT version and the AID 12 field being 2007 is decoded, the corresponding user information field 406 is interpreted as an EHT format.

For an UHR non-AP STA, when the special user information field 402 with the PHY version identifier indicating the EHT version and the AID 12 field being 2007 is decoded, the corresponding user information field 406 is interpreted as an EHT format. Afterwards, when the special user information field 404 with the PHY version identifier indicating the UHR version and the AID 12 field being 2007 is decoded, the corresponding user information field 408 is interpreted as an UHR format.

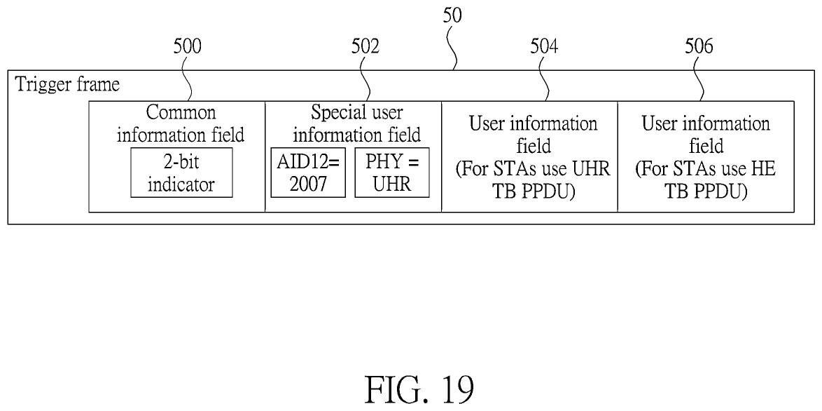

FIG. 19 is a diagram illustrating a second example of a transmission order of a special user information field and multiple user information fields included in a trigger frame 50 according to an embodiment of the present invention, wherein the trigger frame 50 may be arranged to trigger transmission of a UL FD-A-PPDU, and the UL FD-A-PPDU includes a HE generation PPDU and an UHR generation PPDU. In this embodiment, the trigger frame 50 includes a common information field 500, a special user information field 502, and multiple user information fields 504 and 506, wherein the 2-bit indicator included in the common information field 500 indicates that the number of special user information fields is one; the user information field 504 corresponds to the special user information field 502; and the user information field 506 corresponds to a HE non-AP STA. In addition, a length of the user information field 504 is equal to that of the user information field 506 (e.g., 40 bits). The AID12 field and the PHY version identifier in the special user information field 502 are set as 2007 and the UHR version, respectively (labeled as “AID12=2007” and “PHY=UHR” in FIG. 19). It should be noted that, in the trigger frame 50, the special user information field 502 is required to be transmitted immediately after the common information field 500. In this embodiment, the user information field 506 is transmitted after the user information field 504, but the present invention is not limited thereto. In some embodiments, the user information field 506 corresponding to the HE non-AP STA may be transmitted later than the special user information field 502 and earlier than the user information field 504.

For a HE non-AP STA, it treats AID12=2007 as other HE's AID and treats the special user information field as a normal user information field to other HE non-AP STAs. It may interpret following user information fields included in the trigger frame 50 as a HE format.

For an UHR non-AP STA, when the special user information field 502 with the PHY version identifier indicating the UHR version and the AID 12 field being 2007 is decoded, the corresponding user information field 506 is interpreted as an UHR format.

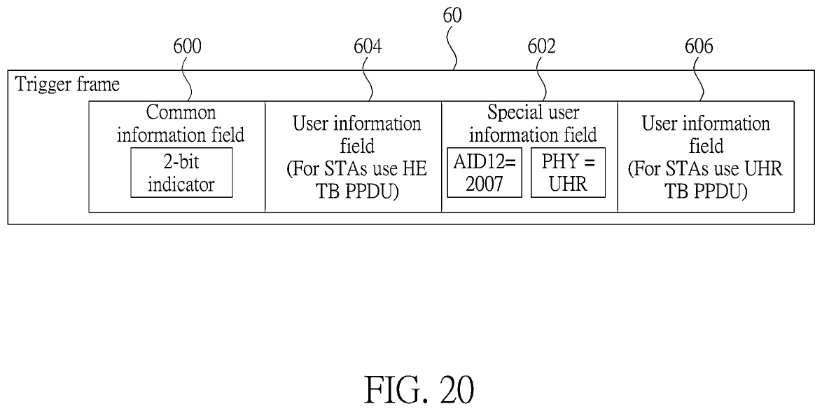

FIG. 20 is a diagram illustrating a third example of a transmission order of a special user information field and multiple user information fields included in a trigger frame 60 according to an embodiment of the present invention, wherein the trigger frame 60 may be arranged to trigger transmission of a UL FD-A-PPDU, and the UL FD-A-PPDU includes a HE generation PPDU and an UHR generation PPDU. In this embodiment, the trigger frame 60 includes a common information field 600, a special user information field 602, and multiple user information fields 604 and 606, wherein the 2-bit indicator included in the common information field 600 indicates that the number of special user information fields is one; the user information field 606 corresponds to the special user information field 602, and is transmitted immediately after the special user information field 602; and the user information field 604 corresponds to a HE non-AP STA. The difference between the trigger frame 50 shown in FIG. 19 and the trigger frame 60 is that, in the trigger frame 60, a length of the user information field 606 is modified from 40 bits to 42 bits. Under this situation, the user information field 604 corresponding to the HE non-AP STA is required to be transmitted earlier than the special user information field 602 and the user information field 606.

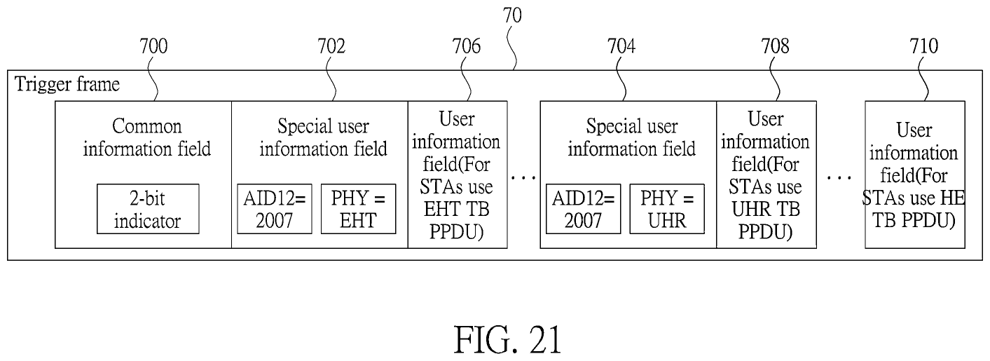

FIG. 21 is a diagram illustrating a fourth example of a transmission order of multiple special user information fields and multiple user information fields included in a trigger frame 70 according to an embodiment of the present invention, wherein the trigger frame 70 may be arranged to trigger transmission of a UL FD-A-PPDU, and the UL FD-A-PPDU includes a HE generation PPDU, an EHT generation PPDU, and an UHR generation PPDU. In this embodiment, the trigger frame 70 includes a common information field 700, multiple special user information fields 702 and 704, and multiple user information fields 706, 708, and 710, wherein the 2-bit indicator included in the common information field 700 indicates that the number of special user information fields is two; the user information field 706 corresponds to the special user information field 702, and is transmitted immediately after the special user information field 702; the user information field 708 corresponds to the special user information field 704, and is transmitted immediately after the special user information field 704; and the user information field 710 corresponds to a HE non-AP STA. In addition, each of the user information fields 706, 708, and 710 has the same length (e.g., 40 bits).

The AID12 field and the PHY version identifier in the special user information field 702 are set as 2007 and the EHT version, respectively (labeled as “AID12=2007” and “PHY=EHT” in FIG. 21), and the special user information field 702 is required to be transmitted immediately after the common information field 700. The AID12 field and the PHY version identifier in the special user information field 704 are set as 2007 and the UHR version, respectively (labeled as “AID12=2007” and “PHY=UHR” in FIG. 21).

For a HE non-AP STA, it treats AID12=2007 as other HE's AID and treats the special user information fields 702 and 704 as a normal user information field to other HE non-AP STAs. It may interpret the following user information fields included in the trigger frame 70 as a HE format.

For an EHT non-AP STA, when the special user information field 702 with the PHY version identifier indicating the EHT version and the AID 12 field being 2007 is decoded, the user information field 706 following the special user information field 702 is interpreted as an EHT format.

For an UHR non-AP STA, when the special user information field 702 with the PHY version identifier indicating the EHT version and the AID 12 field being 2007 is decoded, the user information field 706 following the special user information field 702 is interpreted as an EHT format. Afterwards, when the special user information field 704 with the PHY version identifier indicating the UHR version and the AID 12 field being 2007 is decoded, the user information field 708 following the special user information field 704 is interpreted as an UHR format.

It should be noted that, in this embodiment, the user information field 706 corresponding to the special user information field 702 (i.e., corresponding to an EHT non-AP STA) is required to be transmitted earlier than the user information field 708 corresponding to the special user information field 704 (i.e., corresponding to an UHR non-AP STA). Furthermore, there is no specific transmission order for the user information field 710 corresponding to the HE non-AP STA and the user information field 708 corresponding UHR non-AP STA.

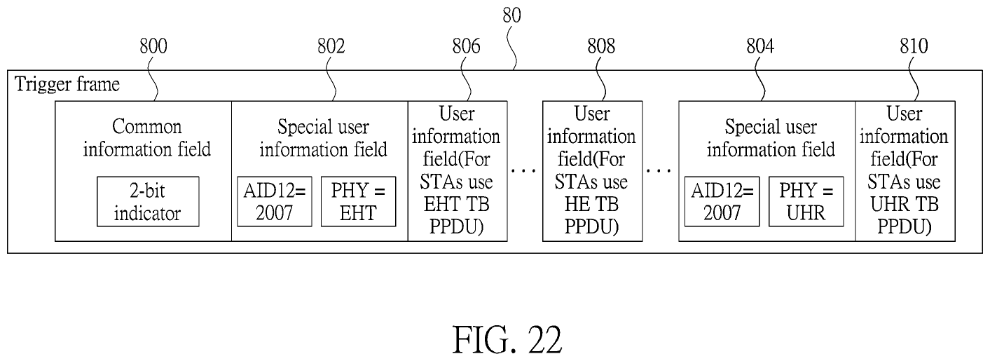

FIG. 22 is a diagram illustrating a fifth example of a transmission order of multiple special user information fields and multiple user information fields included in a trigger frame 80 according to an embodiment of the present invention, wherein the trigger frame 80 may be arranged to trigger transmission of a UL FD-A-PPDU, and the UL FD-A-PPDU includes a HE generation PPDU, an EHT generation PPDU, and an UHR generation PPDU. In this embodiment, the trigger frame 80 includes a common information field 800, multiple special user information fields 802 and 804, and multiple user information fields 806, 808 and 810, wherein the 2-bit indicator included in the common information field 800 indicates that the number of special user information fields is two; the user information field 806 corresponds to the special user information field 802 for EHT, and is transmitted immediately after the special user information field 802; the user information field 810 corresponds to the special user information field 804 for UHR, and is transmitted immediately after the special user information field 804; and the user information field 808 corresponds to a HE non-AP STA.

The difference between the trigger frame 70 shown in FIG. 21 and the trigger frame 80 is that, in the trigger frame 80, a length of the user information field 810 is modified from 40 bits to 42 bits. Under this situation, the user information field 808 corresponding to the HE non-AP STA is required to be transmitted earlier than the special user information field 804 and the user information field 810. In addition, there is no specific transmission order between the user information fields 806 and 808. In some embodiments, the user information field 808 may be transmitted later than the special user information field 802 and earlier than the user information field 806.

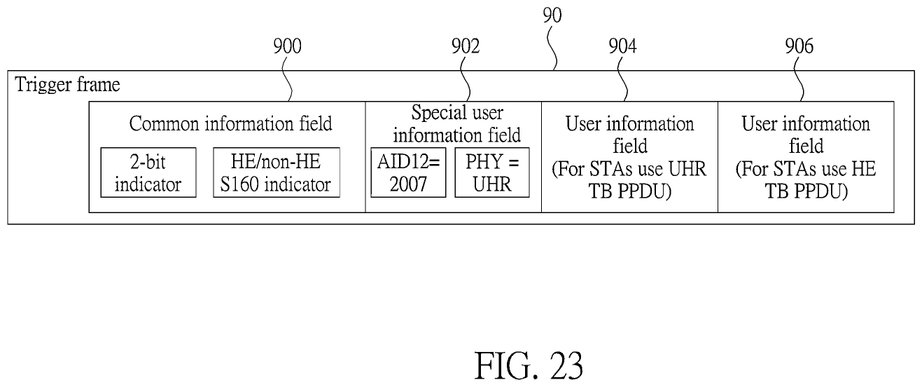

FIG. 23 is a diagram illustrating a sixth example of a transmission order of a special user information field and multiple user information fields included in a trigger frame 90 according to an embodiment of the present invention, wherein the trigger frame 90 may be arranged to trigger transmission of a UL FD-A-PPDU, and the UL FD-A-PPDU includes a HE generation PPDU and an UHR generation PPDU. In this embodiment, the trigger frame 90 includes a common information field 900, a special user information field 902, and multiple user information fields 904 and 906, wherein the 2-bit indicator included in the common information field 900 indicates that the number of special user information fields is one; the user information field 904 corresponds to the special user information field 902; and the user information field 906 corresponds to a HE non-AP STA. The AID12 field and the PHY version identifier in the special user information field 502 are set as 2007 and the UHR version, respectively (labeled as “AID12=2007” and “PHY=UHR” in FIG. 23). The difference between the trigger frame 50 shown in FIG. 19 and the trigger frame 90 is that, the common information field 900 of the trigger frame 90 may further include a HE/non-HE S160 indicator for indicating whether S160 is in a HE format. For example, the HE/non-HE S160 indicator may be B63 in the common information field 900. This is for illustration only, and is not meant to be a limitation of the present invention. In an alternative embodiment, the HE/non-HE S160 indicator is in the special user information field. In some embodiments, the HE/non-HE S160 indicator may be B25 in the special user information field 902.

In summary, by the methods and associated wireless communication devices of the present invention, a FD mask coefficient setting operation can be performed upon a DL FD-A-PPDU for reducing a PAPR of the DL FD-APPDU. In addition, for a case where a UL PPDU is transmitted, design flexibility of a Wi-Fi 8 generation or beyond Wi-Fi generations can be greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for transmitting a downlink (DL) frequency-domain aggregation physical layer protocol data unit (FD-A-PPDU), wherein the DL FD-A-PPDU at least comprises a first PPDU and a second PPDU, and the method comprises:
performing a frequency-domain (FD) mask coefficient setting operation upon at least one field comprised in the first PPDU and at least one field comprised in the second PPDU according to a frequency sub-block in a frequency band used for transmitting the DL FD-A-PPDU, in order to generate a masked FD-A-PPDU, wherein the at least one field comprised in the first PPDU corresponds to the at least one field comprised in the second PPDU; and
transmitting the masked FD-A-PPDU.

2. The method of claim 1, wherein a unit of the frequency sub-block is a multiple of 20 MHZ, and the unit comprises 20 MHZ, 40 MHZ, 80 MHZ, and 160 MHZ.

3. The method of claim 1, wherein a unit of the frequency sub-block is equal to a bandwidth of a PPDU comprised in the FD-A-PPDU.

4. The method of claim 1, wherein the frequency band comprises a first channel for transmitting the first PPDU and a second channel for transmitting the second PPDU; the first channel comprises a plurality of first sub-blocks; the second channel comprises a plurality of second sub-blocks; mask coefficients of a sequence transmitted by at least one first sub-block among the plurality of first sub-blocks are opposite to mask coefficients of a sequence transmitted by at least one second sub-block among the plurality of second sub-blocks; and the at least one first sub-block corresponds to the at least one second sub-block.

5. The method of claim 1, wherein each PPDU comprised in the FD-A-PPDU comprises a legacy preamble field and multiple fields corresponding to each PPDU's Wireless Fidelity (Wi-Fi) generation, and the multiple fields comprise a SIG, a short training field (STF), a long training field (LTF), and a data field.

6. The method of claim 5, wherein the FD mask coefficient setting operation is performed upon the legacy preamble field and the SIG in each PPDU, and the legacy preamble field comprises a L-STF, a L-LTF, a L-SIG, and a RL-SIG.

7. The method of claim 5, wherein the FD mask coefficient setting operation is performed upon the STF, the LTF, and the data field in each PPDU.

8. The method of claim 5, wherein the FD mask coefficient setting operation is performed upon each of the Legacy preamble field, the SIG, the STF, the LTF, and the data field in each PPDU.

9. The method of claim 1, wherein FD mask coefficients set on the at least one field comprised in the first PPDU and the at least one field comprised in the second PPDU are pre-defined FD mask coefficients for a single PPDU, wherein the single PPDU and the FD-A-PPDU have the same bandwidth.

10. A wireless communication device, comprising:
a processor, wherein a downlink (DL) frequency-domain aggregation physical layer protocol data unit (FD-A-PPDU) at least comprises a first PPDU and a second PPDU, and the processor is arranged to perform a frequency-domain (FD) mask coefficient setting operation upon at least one field comprised in the first PPDU and at least one field comprised in the second PPDU according to a frequency sub-block in a frequency band used for transmitting the DL FD-A-PPDU, in order to generate a masked FD-A-PPDU, wherein the at least one field comprised in the first PPDU corresponds to the at least one field comprised in the second PPDU; and
a wireless transceiver circuit, coupled to the processor, and arranged to transmit the masked FD-A-PPDU.

11. A method for transmitting a trigger frame, comprising:
generating a trigger frame for triggering transmission of an uplink (UL) physical layer protocol data unit (PPDU), wherein the trigger frame comprises a common information field, at least one special user information field, and multiple user information fields; the common information field comprises a High Efficiency (HE)/non HE P160 field;
and the HE/non HE P160 field is used for indicating whether a PPDU in P160 is a HE PPDU; and
transmitting the trigger frame.

12. The method of claim 11, wherein the common information field comprises an indicator for indicating whether the trigger frame is used for triggering a frequency-domain aggregation PPDU (FD-A-PPDU).

13. The method of claim 11, wherein the common information field comprises an indicator for indicating a number of special user information fields in the trigger frame.

14. The method of claim 13, wherein the trigger frame comprises a first special user information field with an identifier of a first physical version and a second special user information field with an identifier of a second physical version, a first set of user information fields for stations of the first physical version is located after the first special user information field and before the second special user information field, and a second set of user information fields for stations of the second physical version is located after the second special user information field.

15. The method of claim 11, wherein the UL PPDU is a frequency-domain aggregation PPDU (FD-A-PPDU) comprising a first PPDU and a second PPDU; the first PPDU is an Extremely High Throughput (EHT) PPDU;
and a special user information field with an identifier of EHT version is located immediately after the common information field.

16. The method of claim 11, wherein the trigger frame comprises a first set of user information fields for stations of a first physical version, and a second set of user information fields for stations of a second physical version; each user information field in the first set of user information fields has a first length, and each user information field in the second set of user information fields has a second length; the first set of user information fields is before the second set of user information fields; and the first length is smaller than the second length.

17. A method for transmitting an uplink (UL) physical layer protocol data unit (PPDU), comprising:
receiving a trigger frame, wherein the trigger frame comprises a common information field, at least one special user information field, and multiple user information fields;
the common information field comprises a High Efficiency (HE)/non HE P160 field; and the HE/non HE P160 field is used for indicating whether a PPDU in P160 is a HE PPDU; and
according to a physical (PHY) version identifier in the at least one special user information field and the HE/non HE P160 field, transmitting a UL PPDU.

18. The method of claim 17, wherein a PHY version of the UL PPDU is determined based on the PHY version identifier in the at least one special user information field, and when the HE/non HE P160 field indicates that the PPDU in P160 is not the HE PPDU, the UL PPDU is in P160.

19. The method of claim 17, wherein the common information field comprises an indicator for indicating whether the trigger frame is used for triggering a frequency-domain aggregation PPDU (FD-A-PPDU).

20. The method of claim 17, wherein the trigger frame comprises multiple special user information fields, and the multiple special user information fields comprise:
a first special user information field with an identifier of a first physical version and a second special user information field with an identifier of a second physical version, a first set of user information fields for stations of the first physical version is located after the first special user information field and before the second special user information field, and a second set of user information fields for stations of the second physical version is located after the second special user information field.

21. The method of claim 17, wherein the at least one special user information field comprises a first special user information field; the first special user information field comprises a PHY version identifier indicating an Extremely High Throughput (EHT) version; and in the trigger frame, the first special user information field is transmitted immediately after the common information field.

22. The method of claim 17, wherein the common information field comprises an indicator, and the indicator is arranged to indicate a number of the at least one special user information field.

23. The method of claim 20, wherein the common information field comprises a special user information field flag field and multiple reserved fields, the indicator is a 2-bit indicator, and the 2-bit indicator comprises a bit corresponding to the special user information field flag field and another bit corresponding to one of the multiple reserved fields.
